(19) United States
(12) Patent Application Publication
(10) Pub. No.: US 2006/0074706 A1
(43) Pub. Date: Apr. 6, 2006

(54) Method of handling reply envelopes

(76) Inventor: Dennis Gilham, Stock (GB)

Correspondence Address: PERMAN & GREEN, 425 POST ROAD, FAIRFIELD, CT, 06824, US

(21) Appl. No.: 11/233,476

(22) Filed: Sep. 22, 2005

(30) Foreign Application Priority Data
Sep. 23, 2004 (FR) FR 04 10049

(51) Int. Cl. G06Q 99/00

(52) U.S. Cl. 705/1; 705/406

(57) ABSTRACT

A method of automatically sending a reminder from a sender of a mail item to the addressee of the mail item, the addressee having an obligation to return a sealed reply envelope by a given due date, the method including an operation of sending a reminder letter to the address of the addressee only if a unique reply code that is affixed to the reply envelope and that is read by automatic input means at a collection/delivery office of a postal network is not received at a determined email address at the latest on the given due date.

### TECHNICAL FIELD

The present invention relates to the field of mail handling and relates more particularly to a method of sending reminders for reply envelopes and for monitoring reply envelopes returned to their senders by their addressees.

### PRIOR ART

Nowadays, in spite of the rapid development of e-commerce since the appearance of the Internet, users are still reticent about making payments on-line. Therefore, it is still very common practice to send reply envelopes which are of standard format (and therefore easy to handle automatically), for which postage is prepaid or to which a postage amount is to be affixed, and which serve to receive payments, in particular payments by check, for paying energy bills issued by utilities, for paying rent bills issued by landlords, or for sending payments relating to subscriptions.

Unfortunately, such reply envelopes are costly to handle, in particular when payment is not received by the due date. Payments are always subject to time limits, such as pay-by dates, for example, that must be monitored accurately. In practice, various methods can be implemented for managing such due dates and for sending reminders to the debtors. A first method consists in telephoning the debtor once the due date has been reached. However, such a procedure is particularly costly, and is not liked by debtors. A second method, which is generally computerized, consists in systematically sending a reminder letter on the day after the due date for every letter that has not received a reply on the due date. However, such an automatic procedure suffers from the drawback of sending reminders unnecessarily to people whose payments have not yet arrived even though they have already sent their payments, that happening relatively frequently, in particular when people wait until the last few days before they pay. Unfortunately, such sending of reminders is costly and is also not liked by debtors. Finally, another method consists in sending the reminders only a determined number of days (generally from three to ten days) after the due date. The immediate costs are thus limited but the increase in the payment times adversely affects cash flow, which can give rise to even less desirable financial consequences.

Therefore, there is a currently unsatisfied need for a method of sending reminders to late payers that is of limited overall cost for creditors.

### OBJECTS AND DEFINITION OF THE INVENTION

An object of the present invention is thus to mitigate the above-mentioned drawbacks by proposing a method that enables the sender/creditor to know accurately whether the addressee/debtor has returned the reply envelope within the time limit set for said addressee/debtor, and thus to avoid sending any unnecessary reminders. An object of the invention is also to propose a method that is simple to implement regardless of the postal network (public or private postal network) to which it applies.

These objects are achieved by a method of automatically sending a reminder from a sender of a mail item to the addressee of said mail item, said addressee having an obligation to return a reply envelope by a given due date, said method comprising an operation of sending a reminder letter to the address of the addressee only if a unique reply code that is affixed to said reply envelope and that is read by automatic input means at a collection/delivery office of a postal network is not received at a determined email address at the latest on said given due date.

Thus, as soon as the due date is reached, the sender is informed as to whether or not the reply envelope has been returned by the addressee, and thus, as of the day after said due date, the sender can send a reminder without risking unjustified remarks being made by the addressee.

Depending on the implementation in question, said determined email address may be stored in a database of said collection/delivery office of the postal network in correspondence with said unique reply code or printed on said reply envelope, preferably in the form of a bar code. The unique reply code may also include said determined email address.

Said determined email address may be the address of the sender or the address of a third party appointed by the sender.

Preferably, said unique reply code is a succession of alphanumeric characters, preferably of the optical character recognition (OCR) type, or a one-dimensional or two-dimensional bar code.

Depending on the type of the unique reply code, the read operation may include OCR digitization of said alphanumeric characters or reading/recognition of said bar code, or indeed radio-frequency identity (RFID) reading/writing of the unique reply code written in an RFID tag stuck to said reply envelope.

In a variant implementation, said reply envelope may be formed from an empty reply envelope received in said mail item sent to the addressee by the sender or from a plain envelope on which a reply label is stuck that is received in said mail item sent to the addressee by the sender.

The present invention also provides the above-mentioned method of automatically sending a reminder to a addressee of a mail item, in which method the operation of sending a reminder letter to the address of the addressee only if a unique reply code is not received at a determined email address at the latest on said given due date is replaced with an operation of sending the reminder letter to the address of the addressee only if the unique reply code is not retrieved by the sender at the latest on said given due date from a database in which it has been stored.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 shows an example of interconnected computer networks making it possible to handle mail using the method of the invention; and

FIG. 2 is a flow chart showing the various steps of the method of the invention.

### DETAILED DESCRIPTION OF A PREFERRED IMPLEMENTATION

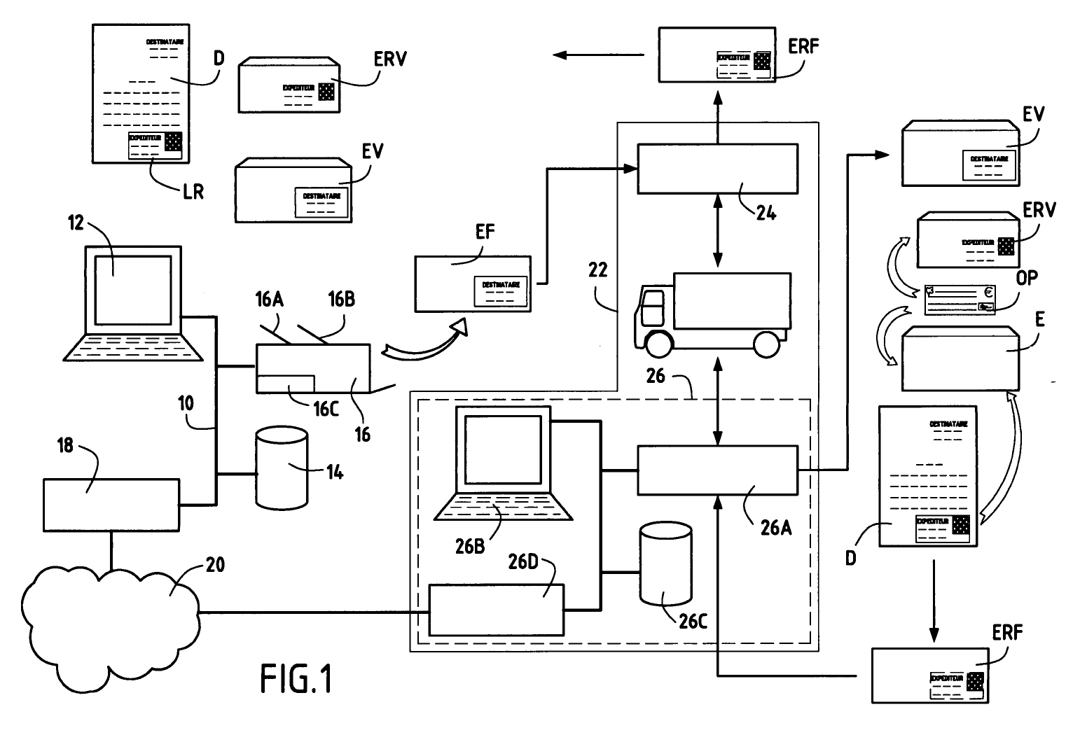

FIG. 1 diagrammatically shows computer network architecture that can exist between a sender and a addressee of a mail item, and that is suitable for implementing the method of the invention for handling reply envelopes.

As shown, the sender has a computer system organized around a local network 10 to which the following, inter alia, are connected, without this list being limiting: one or more computer terminals of the personal computer type 12, for example, one or more databases 14, mail handling apparatus 16 for putting mail items to be sent into envelopes and affixing postage amounts to them, and a modem/router 18 for accessing the Internet 20.

The module 16 conventionally includes a tray 16A for receiving empty envelopes (EVs), a tray 16B for receiving empty reply envelopes (ERVs) that are preferably pre-printed with the address of the sender and optionally with pre-paid postage affixed to them, a tray 16C for receiving blank documents to be printed, a folding module for inserting the documents and/or the empty reply envelope into the empty envelope EV, and a print module for printing both the document and/or the envelopes and a postage amount mark.

Depending on the implementation considered, the empty reply envelope ERV addressed to the sender or the printed document D bearing a reply label LR that is preferably self-adhesive and addressed to the sender, is inserted into the empty envelope EV before the postage amount is affixed thereto. The document D is advantageously printed out from one of the computers 12 by the sender of the mail item, by being transferred electronically to the module 16 via the local network 10 for insertion into an envelope, optionally together with the empty reply envelope, in order to deliver a sealed enveloped EF. Naturally, the presence of said module is not essential to implementing the method of the invention, it being possible to print out the document locally, it then being inserted into an envelope manually and the postage amount then being affixed to the envelope manually.

In the invention, and as a function of the contents of the sealed envelope EF, the document to be sent D or the empty reply envelope ERV is provided with a unique reply code (Code) which makes it possible to associate the document with a determined recording in the database 14, i.e. with a specific file of a specific application of the sender that is related to the contents of the document.

In a preferred application of the present invention, the reply envelope serves to receive a payment from the addressee by check or by any other equivalent payment means, the addressee being a debtor owing a sum of money to the sender who is thus a creditor. In which case, the specific file is, in general, the creditor's customer accounts file which contains the amount to be paid by the debtor and also a customer reference, a number, and a date of invoice, for example.

The unique code is advantageously in the form of a bar code (that is one-dimensional or preferably two-dimensional for its error correction capacity) or of alphanumeric characters printed in or very close to the sender address zone on the empty reply envelope ERV or on the reply label LR of the printed documents. In a variant, said unique code can also be recorded in an RFID tag stuck to the reply envelope or to the reply label.

The sealed envelope EF containing the reply envelope (or the document bearing the reply label) to be sent can then be sent to its addressee via a postal network 22 of a private carrier or of the postal administration. It is firstly received, in the departure city, at a first collection/delivery office 24 of the carrier or of the administration, where it is sorted before being sent to the destination city, to a second collection/delivery office 26 of the carrier or of the administration, where it is finally delivered to its final addressee. The envelope is then opened by the addressee and its reply envelop ERV or its document D is extracted from it. Each collection/delivery office conventionally has an inward mail sorting module 26A connected to a computer system 26 and a database 26C. Preferably, a router/modem 26D makes it possible to access said database via the Internet 20, to which it is connected.

Depending on the contents of the envelope as opened, the addressee inserts a payment order OP, e.g. a check, a direct debit order, or some other equivalent payment means either into the empty reply envelope ERV, or into any envelope E to which the reply label LR enclosed with the document D is stuck. The resulting sealed reply envelope ERF is then ready to be returned to its original sender by a private carrier or by the postal administration via the respective postal network.

However, in the invention, at the inward mail sorting module 26A of the collection/delivery office 26 of the private carrier or of the postal administration, the unique reply code borne by the sealed reply envelope ERF is read by means of a conventional automatic input device such as a digitizer, a digital camera, a bar code reader, an OCR reader or indeed an RFID tag reader (depending on the type of the unique code), and it is transmitted to the sender on the same day, via the Internet 20. For this purpose, the email address details of the sender are pre-recorded in the database 26C. However, provision can be made for said email address details to be present directly in the unique reply code or indeed present next to said unique reply code in a separate bar code, as is known under the name “Postnet code” or “4-state code”. It is also possible to make provision for said transmission to take place to a third party specially appointed by the sender to send customer reminders, it being possible for said reminders to be sent via the Internet if the addressee has an email address known to the third party.

Naturally, in parallel, the reply envelope containing its payment continues to travel through the postal network to reach the sender a few days later.

Thus, with the present invention, the sender (or the above-mentioned third party) is informed that the reply envelope has been returned by the addressee well before said reply envelope arrives, and can thus refrain from sending an unnecessary reminder. In addition, the sender or the third party knows as soon as the due date is reached whether or not the addressees have returned their reply envelopes and can thus, as of the day after said due date, and without waiting for any “honeymoon period” whatsoever, send reminders to negligent or intentionally late payers without any risk of them disapproving.

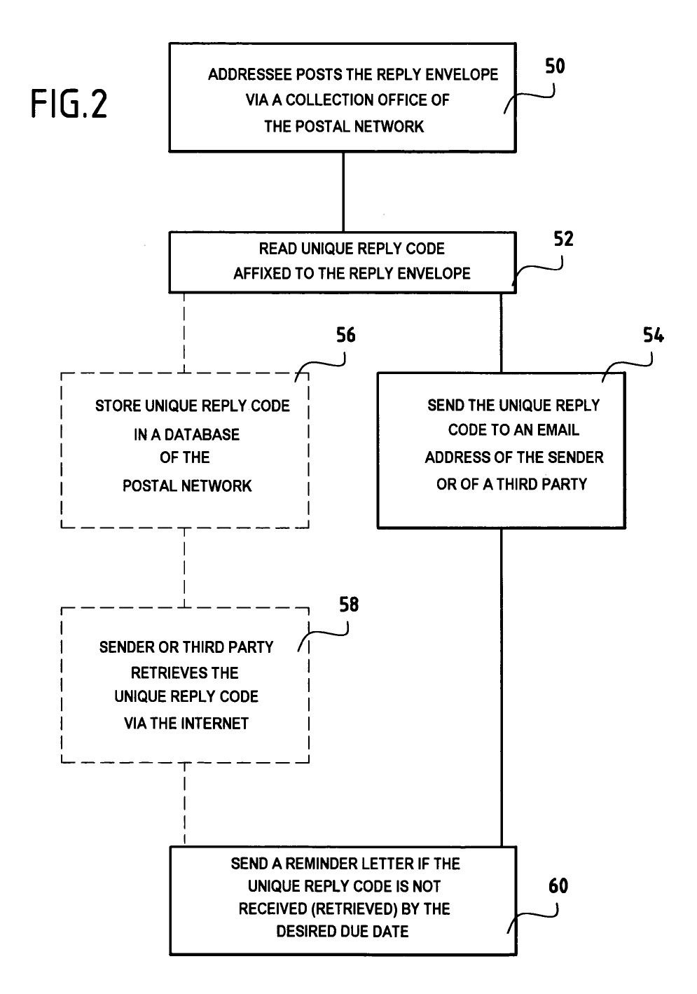

The method of handling reply envelopes thus comprises both a method of automatically monitoring the reply envelopes that is not claimed in the claims, and also a method of automatically sending reminders to addressees on the basis of said monitoring, the various steps of the methods being summarized in the flow chart of FIG. 2.

The automatic monitoring method naturally assumes that the reply envelope has been received by the addressee and thus that the sender has first sent it in an envelope addressed to the addressee, that sending via a postal network itself being preceded by printing a unique reply code on a reply envelope or on a reply label enclosed with a document, the unique reply code being in the form of a bar code (a one-dimensional or preferably a two-dimensional bar code) or of alphanumeric characters. The unique code, which can advantageously include the email address of the sender, can also be written in an RFID tag stuck to the reply envelope or to the above-mentioned reply label.

The first step 50 consists, for the addressee, in posting the reply envelope in which a means of payment has been enclosed via a collection/delivery office of the postal network so as to enable it to be returned to the sender.

Then, at said office, firstly in a following step 52, the unique reply code affixed to the reply envelope is read by automatic input means, and then in a step 54, the unique reply code is sent via the Internet to a determined email address of the sender or of a third party appointed by said sender and whose computer is connected to the Internet.

In a variant of step 54, the above-mentioned operation of sending the unique reply code to the email address can be replaced with a step 56 of storing the single reply code in any database of the postal network that is accessible via the Internet, and by a step 58 in which the unique reply code stored in the database is retrieved by the sender, i.e. via the Internet.

This monitoring then makes it possible to implement the method of automatically sending a reminder to the addressee depending on whether or not the unique reply code is received at the email address of the sender or of a third party appointed by said sender, at the latest on the due date set by the sender (step 60).

In a variant, the reminder letter is sent only if the unique reply code is not retrieved by the sender at the latest by said given due date from the database in which it was stored previously.

Although the invention is described above in detail with reference to a payment application, it is naturally not limited to this field alone. In particular, use of it can be considered for enrolling for an event of any type, such as a conference or a lecture, at which the number of places is limited, or indeed for receiving a gift or any benefit whatsoever, the numbers of which are also limited.

What is claimed is:

1. A method of automatically sending a reminder from a sender of a mail item to the addressee of said mail item, said addressee having an obligation to return a reply envelope by a given due date, said method comprising an operation of sending a reminder letter to the address of the addressee only if a unique reply code that is affixed to said reply envelope and that is read by automatic input means at a collection/delivery office of a postal network is not received at a determined email address at the latest on said given due date.

2. A method according to claim 1, wherein said determined email address is stored in a database of said collection/delivery office of the postal network in correspondence with said unique reply code.

3. A method according to claim 1, wherein said determined email address is printed on said reply envelope, preferably in the form of a bar code.

4. A method according to claim 1, wherein said unique reply code includes said determined email address.

5. A method according to claim 1, wherein said determined email address is the address of the sender.

6. A method according to claim 1, wherein said determined email address is the address of a third party appointed by the sender.

7. A method according to claim 1, wherein said unique reply code is a succession of alphanumeric characters, preferably of the OCR type, or a one-dimensional or two-dimensional bar code.

8. A method according to claim 6, wherein the read operation includes OCR digitization of said alphanumeric characters.

9. A method according to claim 6, wherein the read operation includes reading/recognition of said bar code.

10. A method according to claim 6, wherein the read operation includes RFID reading/writing of the unique reply code written in an RFID tag stuck to said reply envelope.

11. A method according to claim 1, wherein said reply envelope is formed from an empty reply envelope received in said mail item sent to the addressee by the sender.

12. A method according to claim 1, wherein said reply envelope is formed from a plain envelope on which a reply label is stuck that is received in said mail item sent to the addressee by the sender.

13. A method of automatically sending a reminder to a addressee of a mail item according to claim 1, wherein the operation of sending a reminder letter to the address of the addressee only if a unique reply code is not received at a determined email address at the latest on said given due date is replaced with an operation of sending the reminder letter to the address of the addressee only if the unique reply code is not retrieved by the sender at the latest on said given due date from a database in which it has been stored.
